(19) United States
(12) Patent Application Publication
(10) Pub. No.: US 2016/0070763 A1
(43) Pub. Date: Mar. 10, 2016

(54) PARALLEL FREQUENT SEQUENTIAL PATTERN DETECTING

(71) Applicants: Lijun ZHAO, Haidian District (CN); TERADATA US, INC., Dayton, OH (US)

(72) Inventors: Yu Wang, Haidian District (CN); Yuyang Liu, Chaoyang District (CN); Huijun Liu, Hengyang (CN); Lijun Zhao, Haidian District (CN); Wenjie Wu, Shijingshan District (CN)

(73) Assignee: TERADATA US, INC., DAYTON, OH (US)

(21) Appl. No.: 14/361,132

(22) PCT Filed: May 31, 2013
(86) PCT No.: PCT/CN2013/076572

§ 371 Date: May 28, 2014

(51) Int. Cl. G06F 17/30

(52) U.S. Cl. CPC G06F 17/30539; G06F 17/30598; G06F 17/30867

(57) ABSTRACT

Techniques for parallel frequent sequential pattern detection are provided. A sequence database is split into separate datasets and each node is given a specific dataset to resolve specific frequent items occurring in its specific dataset based on counts. Then, each node groups its item frequent items into “n” (varying) length sequences representing sequential patterns present in the original sequence database. The nodes process in parallel with one another and collectively produce a complete set of the sequential patterns defined in the original sequence database.

### BACKGROUND

After over two-decades of electronic data automation and the improved ability for capturing data from a variety of communication channels and media, even small enterprises find that the enterprise is processing terabytes of data with regularity. Moreover, mining, analysis, and processing of that data have become extremely complex. The average consumer expects electronic transactions to occur flawlessly and with near instant speed. The enterprise that cannot meet expectations of the consumer is quickly out of business in today's highly competitive environment.

Consumers have a plethora of choices for nearly every product and service, and enterprises can be created and up-and-running in the industry in mere days. The competition and the expectations are breathtaking from what existed just a few short years ago.

The industry infrastructure and applications have generally answered the call providing virtualized data centers that give an enterprise an ever-present data center to run and process the enterprise's data. Applications and hardware to support an enterprise can be outsourced and available to the enterprise twenty-four hours a day, seven days a week, and three hundred sixty-five days a year.

As a result, the most important asset of the enterprise has become its data. That is, information gathered about the enterprise's customers, competitors, products, services, financials, business processes, business assets, personnel, service providers, transactions, and the like.

Updating, mining, analyzing, reporting, and accessing the enterprise information can still become problematic because of the sheer volume of this information and because often the information is dispersed over a variety of different file systems, databases, and applications. In fact, the data and processing can be geographically dispersed over the entire globe. When processing against the data, communication may need to reach each node or communication may entail select nodes that are dispersed over the network.

One area of technology that has focused on analyzing and mining patterns in data is a technique referred to as Sequence Pattern Detection. Sequence Pattern Detection is widely used in a variety of different applications, including but not limited to purchase behavior analysis, web log analysis, and gene sequence analysis.

Several algorithms, such as Generalized Sequential Pattern (GSP) algorithm and Prefix-projected Sequential pattern mining (Prefix Span), were created from various research efforts to solve this important problem. However, all these algorithms would run into performance limitations when the data set being mined involved gets very large. The techniques are designed to run on a single machine, and therefore are unable to make use of the collective resources in a multi-machine parallel computing system.

### SUMMARY

In various embodiments, techniques for parallel frequent sequential pattern detection are presented. According to an embodiment, a method for parallel frequent sequential pattern detection is provided.

Specifically, (a) a subsequence is obtained for each sequence in a sequence database and grouping the subsequence with a first item; (b) the subsequences are redistributed to nodes of a parallel processing networking by a prefix value; (c) a specific prefix with a predefined length is counted at each node a high frequency prefix and its postfix are maintained at each node; (d) new prefixes are generated at each node that combine the specific prefix and specific subsequences of its postfix; (c) and (d) are iterated, at each node and in parallel, until no new prefixes are generated or until a given prefix length exceeds a specified value; and finally, all the prefixes are output.

### BRIEF DESCRIPTION OF THE DRAWINGS

FIG. 1 is a diagram of a method for parallel frequent sequential pattern detection, according to an example embodiment.

FIG. 2 is a diagram of another method for parallel frequent sequential pattern detection, according to an example embodiment.

FIG. 3 is a diagram of a parallel frequent sequential pattern detection system, according to an example embodiment.

### DETAILED DESCRIPTION

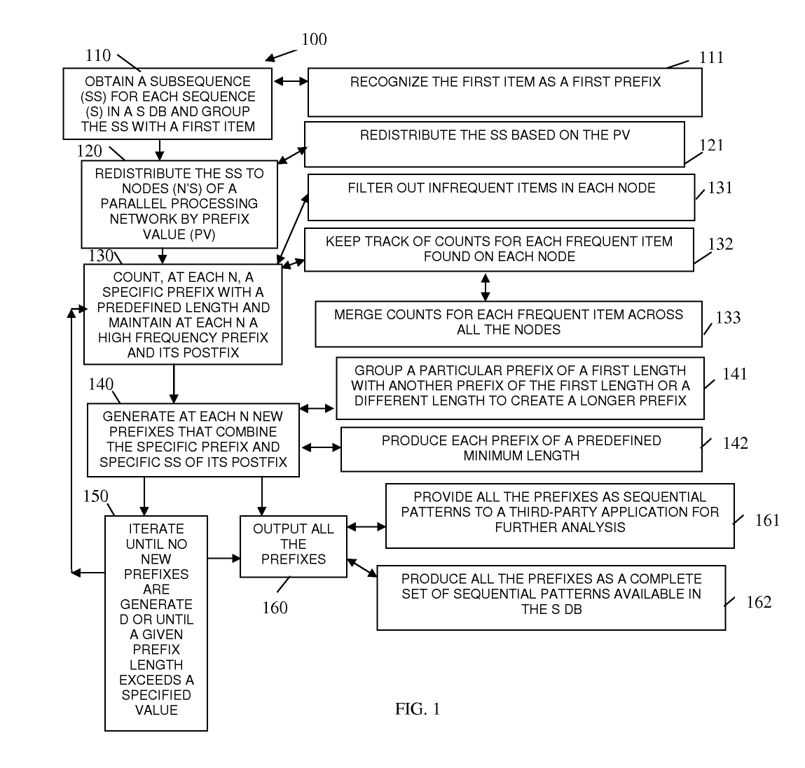

FIG. 1 is a diagram of a method 100 for parallel frequent sequential pattern detection, according to an example embodiment. The method 100 (hereinafter “parallel pattern detection manager”) is implemented as executable instructions that are programmed and reside within memory and/or non-transitory computer-readable storage media for execution on processing nodes (processors) of a network; the network wired, wireless, and/or a combination of wired and wireless.

Before discussing the processing identified for the parallel pattern detection manager presented in the FIG. 1, some embodiments, examples, and context of the parallel pattern detection manager and some sample pseudo code are presented for comprehension and illustration.

Let I={i₁; i₂; ;} be a set of all items. An itemset is a subset of items. A sequence is an ordered list of itemsets. A sequence s is denoted by <s₁s₂ . . . sₗ>, where sⱼ is an itemset. sⱼ is also called an element of the sequence, and denoted as (x₁x₂ . . . xₘ), where xₖ is an item. For brevity, the brackets are omitted if an element has only one item, i.e., element (x) is written as x. An item can occur at most once in an element of a sequence, but can occur multiple times in different elements of a sequence. The number of instances of items in a sequence is called the length of the sequence. A sequence with length l is called an l-sequence. A sequence α=<a₁a₂ . . . aₙ> is called a subsequence of another sequence β=<b₁b₂ . . . bₘ> denoted as α⊂β, if there exist integers 1≦j₁<j₂< . . . <jₙ≦m such that a₁⊂bⱼ₁; a₂⊂bⱼ₂; . . . ; aₙ⊂bⱼₙ.

Given a set of sequences and the min_support threshold, sequence pattern detecting is to find the complete set of frequent patterns in the sequences.

For example, there are 4 sequences in the sequence data set. <a(abc)(ac)d(cf)> is a sequence. (abc) is an item set, there are three items in the item set. In this example, <a(bc)> is a subsequence of <a(abc)(ac)d(cf)>, and <(ad)c(bc)(ae)>. If the min_support threshold is 2, it is a frequent pattern.

Example sequence data set

| UserId | SID | sequence |
|---|---|---|
| 1 | 10 | <a(abc)(ac)d(cf)> |
| 1 | 20 | <(ad)c(bc)(ae)> |
| 1 | 30 | <(ef)(ab)(df)cb> |
| 1 | 40 | <eg(af)cbc> |

### PrefixSpan

PrefixSpan is a projection-based sequential pattern-growth approach for efficient mining of sequential patterns. The general idea is to use frequent items to recursively project sequence databases into smaller projected databases and grow subsequence fragments in each projected database.

It is a deep-first algorithm. Research shows that it is more efficient than a GSP algorithm.

```
  Input: A sequence database S, and the minimum support
threshold_min support.
  Output: The complete set of sequential patterns.
  Approach: PrefixSpan(a, l, S/a)
  Parameters:
    a is a sequential pattern;
    l is the length of a;
    S/a is the a-projected database if a!=<>, otherwise, it is the
sequence data set S.
```

Description:

1. Scan S/a once, find each frequent item, b, such that
(a) b can be assembled to the last element of a to form a sequential pattern; or
(b) <b> can be appended to a to form a sequential pattern.

2. For each frequent item b, append it to a to form a sequential pattern a′, and output a′.

3. For each a′, construct a′-projected database S/a′, and call PrefixSpan(a′, l+1, S|a′).

PrefixSpan faces the following resource challenges:

1. Memory limitation—the algorithm was based on a recursive calling of the PrefixSpan function. Therefore multiple projected databases need to load into memory at the same time. The memory size will be a limitation to process very huge sequence data set. It is necessary to use a non-recursive algorithm, which made each projected database can be processed independently.

2. Storage—all the sequence data set needs to be stored in single machine to count the sequences that containing a specific item. It is unable to make use of the collective resources in a multi-machine parallel computing system. Distribute the prefix and projected database into multiple machines will make the processing can be parallelized.

3. Failover—the whole processing need to redo when some exception case occurred. Map/reduce model has the mechanism for recovering from failures. The failure map/reduce tasks can be restart easily.

### Novel Parallel PrefixSpan Approach

A Parallel PrefixSpan is presented, which decomposes a large recursive processing into independent, parallel tasks. A map/reduce model is used to take advantage of its parallel processing capability and recovery mechanism.

The sequence data sets are distributed to multiple machines. The first map/reduce task finds frequent items in the sequence, and redistributes the dataset by items. Therefore, all the sequences having a frequent item are stored into one node. The frequent item is the length of 1 frequent pattern; all length “n” frequent patterns are grown from the frequent item by finding and merging frequent items in its projected database continuously. The projected database is shrinking with the growth of the length of the pattern. Each frequent pattern is generated from one specific prefix and its projected database. After the first map/reduce task, if the data set in one node can be processed in its node, then no redistribution is needed. Otherwise, the processing can be repeated 2 or more times for frequent items to divide the dataset multiple times.

The second map/reduce task groups the postfix data set as a projected database by prefix. For each prefix, scan the postfix data set to find the containing frequent items. Then, grow the prefix with the frequent items, and generate new prefix groups. The tasks are ended if all the groups are scanned and no new groups are generated. All the prefixes are output as the frequent pattern.

There are 2 steps to implement the Novel Parallel PrefixSpan. The first step counts the items in the sequence dataset to get the frequent items. The second step groups the prefixes and generates new prefixes with longer lengths.

Step 1. Parallel generate a frequent length of 1 sequence, and the postfix data sets of the sequence. The Map function is called first to count in its local machine. The Reduce function merges the count result together and filters off the infrequent items. Some sample pseudo code for achieving step 1 follows:

```
class Postfix
{
  int sequenceId;
  List<int> position; // The position of the items in the prefix.
  List(Set(text)) sequence; // The postfix subsequence.
}
void map(String name, String sequences)
// name: sequence data set name
// sequences: sequence set
  for each sequence in sequence set{
    generate item PostfixMap(String item, Postfix postfix);
      for each item in the itemset{
        if (item not in the item PostfixMap){
          String postfixText = getPostfix(sequence, item);
          itemPostfixMap.insert (item,
              Postfix(sequenceId, position, postfixText));
            }
          }
        }
      }
      for each item in the itemMap
        output(item, postfix);
}
void reduce(String item, Postfix postfix)
// item: length 1 sequence
// postfix: the postfix of the item in the sequence
  Int count = 0;
  for each item
      count++;
    if count > min_support
        output(item, count, postfix);
}
```

Step 2. In each node, group the item-projections by the prefix. For each group, run the map function to generate n length subsequences. The map function will run recursively until there is no new sequence generated or the subsequence length exceeds a threshold. Each iteration generates n+1 length subsequences. Some sample pseudo code for step 2 is as follows.

```
void map(String prefix, Postfix postfix)
// prefix: length n sequence
// postfix: the postfix of the prefix
    Int count = 0;
  generate itemMap(String item, int count);
  for each postfix{
        for each item b in the postfix
          if (b in the itemMap)
            itemMap.put(b, count++);
          else
            itemMap.insert(b,1);
    } // Generate itemMap for each item in the postfix.
    for each postfix{
        For each item b in the itemMap;
          If (count > min_support)
              Output <prefix(prefix+b),count, new postfix(postfix)>;
      } // Generate n + 1 subsequences, and their postfix.
}
```

As will be demonstrated more completely and fully herein, the techniques solve the scale-out problem for frequent pattern detecting. Existing approaches cannot handle the case when the data set of sequence is too huge to store in one node. The approach herein is a novel parallelized algorithm on distributed machines. The performance is improved by use of multiple CPU, memory and storage resources by map/reduce framework.

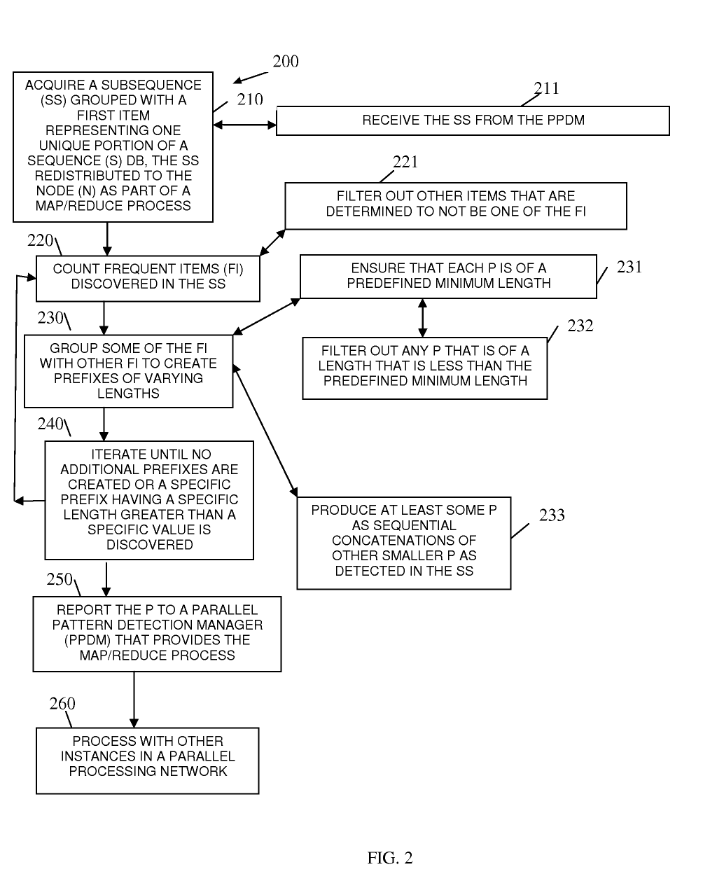

At 110, the parallel pattern detection manager obtains a subsequence for each sequence in a sequence database and the subsequence is grouped with a first item. A sequence database is essentially divided into subsequences and each subsequence is assigned to a node of a parallel processing network. The processing from the perspective of a particular node is provided below with the discussion of the FIG. 2.

According to an embodiment, at 111, the parallel pattern detection manager recognizes the first item as a first or initial prefix.

At 120, the parallel pattern detection manager redistributes the subsequences to nodes of a parallel processing network by prefix value.

In an embodiment, at 121, the parallel pattern detection manager redistributes the subsequences based on the prefix value.

At 130, the parallel pattern detection manager counts, at each node, a specific prefix with a predefined length and maintains at each node a high frequency prefix and its postfix.

According to an embodiment, at 131, the parallel pattern detection manager filters out infrequent items in each node.

In another case, at 132, the parallel pattern detection manager keeps track of counts for each frequent item found on each node.

Continuing with the embodiment of 132 and in a variation of 132 at 133, the parallel pattern detection manager merges counts for each frequent item across all the nodes.

At 140, the parallel pattern detection manager generates, at each node, new prefixes that combine the specific prefix and specific subsequences of its postfix.

In an embodiment, at 141, the parallel pattern detection manager groups a particular prefix of a first length with another prefix of the first length or a different length to create a longer prefix.

In yet another situation, at 142, the parallel pattern detection manager produces each prefix of a predefined minimum length.

At 150, the parallel pattern detection manager iterates the processing back at 130 and 140 until there are no new prefixes generated or until a given prefix length exceeds a specified value.

At 160, the parallel pattern detection manager outputs all the prefixes.

In an embodiment, at 161, the parallel pattern detection manager provides all the prefixes as sequential patterns to a third-party application for further analysis to achieve a variety of things for business and governmental actions.

In another case, at 162, the parallel pattern detection manager produces all the prefixes as a complete set of sequential patterns available in the sequence database.

It is noted that the set of sequential patterns is produced using a map-reduce parallel processing technique.

FIG. 2 is a diagram of another method 200 for parallel frequent sequential pattern detection, according to an example embodiment. The method 200 (hereinafter “parallel frequent pattern detection controller”) is implemented as executable instructions within memory and/or non-transitory computer-readable storage media that execute on one or more processors (nodes), the processors specifically configured to process the parallel frequent pattern detection controller. The parallel frequent pattern detection controller is also operational over a network; the network is wired, wireless, or a combination of wired and wireless.

The parallel frequent pattern detection controller presents another and in some ways an enhanced perspective of the parallel pattern detection manager presented above with respect to the FIG. 1. Specifically, the parallel pattern detection manager represents a centralized server manager combined with node processing and the parallel frequent pattern detection controller represents one node processing a portion of a sequence database (subsequence) that the parallel pattern detection manager coordinates with other processing instances of the parallel frequent pattern detection controller over the parallel processing network.

At 210, the parallel frequent pattern detection controller acquires a subsequence representing a unique portion of a sequence database. The subsequence is redistributed to the node that processes the instance of the parallel frequent pattern detection controller as part of a map/reduce processing, such as the one performed by the parallel pattern detection manager (discussed above with reference to the FIG. 1).

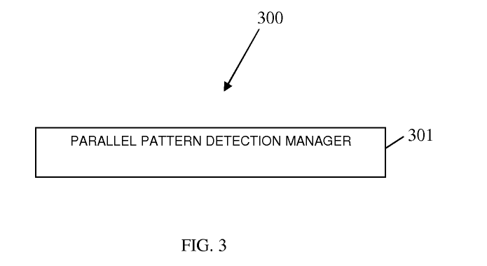

In an embodiment, at 211, the parallel frequent pattern detection controller receives the subsequence from a parallel pattern detection manager, discussed above with respect to the FIG. 1 and below with the FIG. 3.

At 220, the parallel frequent pattern detection controller counts for frequent items discovered within the subsequence.

In an embodiment, at 221, the parallel frequent pattern detection controller filters out of other items that are determined to not be one of the frequent items.

At 230, the parallel frequent pattern detection controller groups some of the frequent items with other frequent items to create prefixes of varying lengths.

In an embodiment, at 231, the parallel frequent pattern detection controller ensures that each prefix is of a predetermined minimum length.

Continuing with the embodiment of 231 and at 232, the parallel frequent pattern detection controller filters out any prefix that is of a length that is less than the predefined minimum length.

In another case, at 233, the parallel frequent pattern detection controller produces at least some prefixes as sequential concatenations of other smaller prefixes as detected in the subsequence. So, some patterns include other smaller patterns.

At 240, the parallel frequent pattern detection controller iterates the processing at 220 and 230 until no additional prefixes are created or until a prefix having a specific length greater than a specific value is discovered.

At 250, the parallel frequent pattern detection controller reports the prefixes to a parallel pattern detection manager for assimilation, such as the parallel pattern detection manager discussed above with respect to the FIG. 1 and again below with reference to the FIG. 3.

According to an embodiment, at 250, the parallel frequent pattern detection controller processes as one instance within a parallel processing network having other instances of the parallel frequent pattern detection controller processing in parallel. The parallel pattern detection manager coordinates the instances to produce a complete set of patterns mined from the sequence database.

FIG. 3 is a diagram of a parallel frequent sequential pattern detection system 300, according to an example embodiment. The components of the parallel frequent sequential pattern detection system 300 are implemented as executable instructions that are programmed and reside within memory and/or non-transitory computer-readable storage medium that execute on processing nodes of a network. The network is wired, wireless, or a combination of wired and wireless.

The parallel frequent sequential pattern detection system 300 implements, inter alia, the methods 100 and 200 of the FIGS. 1 and 2.

The parallel frequent sequential pattern detection system 300 includes a parallel pattern detection manager 301.

Each processing node includes memory configured with executable instructions for the parallel pattern detection manager 301. The parallel pattern detection manager 301 processes on the processing nodes. Example processing associated with the parallel pattern detection manager 301 was presented above in detail with reference to the FIGS. 1 and 2.

The parallel pattern detection manager 301 is configured to manage and to use a plurality of nodes in a parallel processing network to resolve a complete set of sequential patterns that are mined from a sequence database. This is largely done by breaking the sequence database into datasets and having each node process a particular dataset to resolve specific patterns in that node's dataset. The manner in which this is done was presented above in detail with reference to the FIG. 1. Processing associated with each of the nodes was presented above with respect to the FIG. 2.

According to an embodiment, the parallel pattern detection manager 301 is also configured to merge and collect specific patterns and produce the complete set of the sequential patterns when each node has completed processing on that node's dataset.

In another case, the parallel pattern detection manager 301 is configured to automatically feed the complete set of sequential patterns to a variety of analysis services. So, mining services can use the patterns to take other actions or make assumptions about the patterns. Such actions can facilitate business or even governmental activities.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method implemented and programmed within a non-transitory computer-readable storage medium and processed by machine, the machine configured to execute the method, comprising:
(a) obtaining, at the machine, a subsequence for each sequence in a sequence database and group the subsequence with a first item;
(b) redistributing, at the machine, the subsequences to nodes of a parallel processing networking by a prefix value;
(c) counting, at each node and in parallel, a specific prefix with a predefined length and maintaining at each node a high frequency prefix and its postfix;
(d) generating, at each node and in parallel, new prefixes that combine the specific prefix and specific subsequences of its postfix;
(e) iterating, at each node and in parallel, (c) and (d) until no new prefixes are generated or until a given prefix length exceeds a specified value; and
(f) outputting, by the machine, all the prefixes.

2. The method of claim 1, wherein obtaining further includes recognizing the first item as a first prefix.

3. The method of claim 1, wherein redistributing further includes redistributing each subsequence based on its prefix value.

4. The method of claim 1, wherein counting further includes having each node filter out infrequent items.

5. The method of claim 1, wherein counting further includes keeping track of counts on each node for each frequent item found.

6. The method of claim 4, wherein keeping further includes merging counts for each frequent item across all the nodes.

7. The method of claim 1, wherein generating further includes grouping a particular prefix of a first length with another prefix of the first length or a different length to create a longer prefix.

8. The method of claim 1, wherein generating further includes producing each prefix of a predefined minimum length.

9. The method of claim 1, wherein outputting further includes providing all the prefixes as sequential patterns to a third-party application for further analysis.

10. The method of claim 1, wherein outputting further includes producing all the prefixes as a complete set of sequential patterns available in the sequenced database.

11. A method implemented and programmed within a non-transitory computer-readable storage medium and processed by a processing node (node), the node configured to execute the method, comprising:
(a) acquiring, at the node, a subsequence grouped with a first item representing one unique portion of a sequence database, the subsequence redistributed to the node as part of a map/reduce process;
(b) counting, at the node, frequent items discovered in the subsequence;
(c) grouping, at the node, some of the frequent items with other frequent items to create prefixes of varying lengths;
(d) iterating, at the node, (b) and (c) until no additional prefixes are created or a specific prefix having a specific length greater than a specific value is discovered; and
(e) reporting, via the node, the prefixes to a parallel pattern detection manager.

12. The method of claim 11 further comprising, processing the method and other instances of the method in a parallel processing network.

13. The method of claim 11, wherein acquiring further includes receiving the subsequence from the parallel pattern detection manager.

14. The method of claim 11, wherein counting further includes filtering out other items that are determined to not be one of the frequent items.

15. The method of claim 11, wherein grouping further includes ensuring that each prefix is of a predefined minimum length.

16. The method of claim 15, wherein ensuring further includes filtering out any prefix that is of a length that is less than the predefined minimum length.

17. The method of claim 11, wherein grouping further includes producing at least some prefixes as sequential concatenations of other smaller prefixes.

18. A system, comprising:
memory configured with a parallel pattern detection manager that processes on a server of a network;
wherein the parallel pattern detection manager is configured to manage and to use a plurality of nodes in a parallel processing network to resolve a complete set of sequential patterns mined from a sequence database by breaking the sequence database into datasets and have each node process a particular dataset to resolve specific patterns in that node's dataset.

19. The system of claim 18, wherein parallel pattern detection manager is configured to merge and collect the specific patterns and produce the complete set of sequential patterns when each node has completed processing on that node's dataset.

20. The system of claim 18, wherein the parallel pattern detection manager is configured to automatically feed the complete set of sequential patterns to a variety of analysis services.
